(19) United States
(12) Patent Application Publication
(10) Pub. No.: US 2022/0188890 A1
(43) Pub. Date: Jun. 16, 2022

(54) SYSTEM AND METHOD OF COMPARING CROSS-BRAND LEASE, FINANCE, AND/OR PURCHASE DATA FOR FACILITATING THE PURCHASE AND/OR LEASE OF A VEHICLE

(71) Applicant: BROKERBUDDY LLC, Cedar Park, TX (US)

(72) Inventors: Robert Evans, Cedar Park, TX (US); James Evans, Cedar Park, TX (US)

(21) Appl. No.: 17/550,688

(22) Filed: Dec. 14, 2021

Related U.S. Application Data
(60) Provisional application No. 63/125,970, filed on Dec. 15, 2020.

(51) Int. Cl. G06Q 30/06; G06Q 40/02; G06F 3/0482

(52) U.S. Cl. CPC G06Q 30/0619; G06Q 30/0611; G06F 3/0482; G06Q 40/025; G06Q 30/0627

(57) ABSTRACT

A system and a method of facilitating purchase and/or lease of an automobile are disclosed. The system Automotive Sales Representative receives information from a customer or buyer for purchasing and/or leasing an automobile. The system allows an automotive retail sales or leasing representative to select one or more automobiles based on the information provided by the customer. The system selects purchase options for the customer. Further, the system selects a dealership which offers best pricing for the automobile suitable for the customer. The system checks inventory at the dealership and obtains an invoice from the dealership. Subsequently, the system checks rebates, insurance and other finance and insurance data applicable for the customer. Further, the system generates a deal structure or buyer order and transmits to the customer. The system allows automotive retail sales representatives to provide a buyer order or sales quote instantly to the customer.

### CROSS-REFERENCE TO RELATED APPLICATIONS

The present application claims priority from U.S. Provisional Patent Application Ser. No. 63/125,970, filed on Dec. 15, 2020, which is incorporated herein by its entirety and referenced thereto.

### FIELD OF INVENTION

The present subject matter generally relates to brokering and managing automobile sales leads. More specifically, the present subject matter relates to a system and method of facilitating purchase of an automobile based on requirement of a customer by an automotive retail sales representative.

### BACKGROUND OF INVENTION

It is known that conventional methods of purchasing or leasing a vehicle have been, currently are, and will continue to be challenged by a recently emboldened group of intermediaries that have found a considerable share of the retail automotive target market. Customers often search for more convenient, safe, and efficient alternatives to the conventional methods. These include, but not limited to, going to a dealership or multiple dealerships, talking with multiple sales representatives, negotiating a price in the dealership, then waiting for the dealership to prepare the vehicle while the customer sits with a finance manager when they are available to go over a contract, prove insurance, and discuss additional warranties, options, or coverages. After completing required formalities, the customer leaves with a new vehicle. Such conventional method is already outdated, and more independent automotive retail sales representatives have entered the process to negotiate on behalf of the customer, pick up their new vehicle, deliver the vehicle to their home, and sign contracts at customer's convenience. For customers, this ensures that they don't have to wait, or visit dealerships and waste the time. Like many challenges, when a group of intermediaries prove to resolve a set of challenges for the consumer, new challenges emerge for the intermediary.

In order to overcome the difficulties discussed above, new frontier intermediaries have been forced to adapt conventional software created and designed for the conventional automotive sales process to be modified to work for them. One example of a conventional software for identifying vehicles for a purchaser is disclosed in a United States patent Publication No. 20150178809, entitled “System and Method for Identifying Vehicles for A Purchaser” (“the '809 Publication”). The '809 Publication discloses processing of vehicle inventory information that allows vehicles that satisfy financial institution's financing requirements, as well as a purchaser's requirements are described. The inventory information is processed to identify eligible vehicles that meet the purchaser's requirements. The financial requirements are determined from financial booking information that describes how a financial institution determines the financing for vehicles.

Another example is disclosed in a United States patent Publication No. 20140279229, entitled “Systems and Methods for Facilitating Vehicle Transactions” (“the '229 Publication”). The '229 Publication discloses computer-implemented systems and methods for searching vehicle listings. An example method may include receiving one or more financial parameters. The method may also include generating one or more proposed transactions that may be defined, at least in part, by the one or more financial parameters. Additionally, the method may include determining, based at least in part on the one or more proposed transactions, for one or more advertised offers associated with one or more vehicles. The method may also include transmitting at least one advertised offer of the one or more advertised offers.

Yet another example is disclosed in a U.S. Pat. No. 9,037,498, entitled “Method, Medium, and System for Facilitating Vehicle Purchases” (“the '498 Patent”). The '498 Patent discloses that embodiments of the present disclosure provide an effective, user-friendly approach to help a buyer of a car, truck, boat, or other vehicle to get a firm quote from a dealer on a vehicle that the buyer wants, and is financially qualified for, without the hassle and time expense involved in traditional vehicle sales. Embodiments of the present disclosure also help link dealers with buyers who are pre-qualified and motivated to purchase a vehicle, thus helping to eliminate the wasted time, money, and opportunity costs dealers often devote to customers who are not interested in purchasing, and/or who do not financially qualify to purchase, a vehicle.

Although the above-discussed disclosures have varied successes, the automotive retail sales representative that can help a customer with any type of brand of new vehicle, lease, finance, or purchase, must be able to compare pricing to answer the question “Which sedan can I lease for my daughter that is less than $325.00 per month?” At a dealership, they may only have one new model that would fit that description, maybe not at all. A sales representative that can sell anything must be able to find all the vehicles that would fit that customer's needs—which could be 1, 2, 3, or 20 vehicles. A conventional sales representative working at a new car dealership is only required to know the pricing for that manufacturer—that sales representative may only have 1 or 2 vehicles if any that fit that customer's needs.

Therefore, there is a need for a system operated or managed by an automotive retail sales representative that helps to solve all the cumbersome work that the automotive retail sales representative must do to provide a price based on the requirement of the customer.

### SUMMARY

It is an object of the present subject matter to provide a system and method of facilitating purchase and/or lease of an automobile based on requirement of a customer and that avoids the drawback of known techniques.

It is another object of the present subject matter to provide a system capable of generating an automobile sales quote based on requirement or criteria selected by a customer or buyer.

It is another object of the present subject matter to provide a system for use by automotive retail sales or lease representatives to provide sales quote based on requirement of a customer.

In order to achieve one or more objects, the present subject matter provides a system and a method of facilitating purchase and/or lease of an automobile based on requirement of a customer. The system receives information (lead) from a customer for purchasing an automobile. In one example, the automobile includes a new automobile. An automotive retail sales representative automobile/automotive broker or dealer/dealership accesses and operates the system to provide a sales quote based on the information received from the customer. The system displays information of the customer at the top for the automotive retail sales representative to access at all times. The system allows the automotive retail sales representative to search and select one or more automobiles based on the criteria provided by the customer. The system allows the automotive retail sales representative to select purchase options for the customer. Further, the system allows the automotive retail sales representative to select a dealership which offers best pricing for the automobile suitable for the customer.

In the present invention, the system selects the dealership by matching the location of the customer and the dealership, and the purchase structure over the data communication network. This ensures the system gets most appropriate dealership offering the automobile as per the purchase structure preferred by the customer and is closer to the location of the customer. After selecting the dealership, the system allows the automotive retail sales representative to check inventory at the dealership and obtain an invoice from the dealership or fleet manager of the dealership.

Subsequently, the system checks rebates, and other finance data applicable for the customer. Further, the system generates a deal structure or buyer order and transmits to the customer. The system provides immediate pricing or sales quote according to filters selected by the automotive retail sales representative based on the customer's requirement. In one implementation, the system allows the automotive retail sales representative to track how many customers are coming out of their lease for providing sales quote for them to purchase a new automobile.

In one advantageous feature of the present subject matter, the system solves an Internet-centric problem that is necessarily rooted in a computer technology by allowing the automotive retail sales representative to search for multiple vehicles at a time that match the criteria provided by the customer. The present invention provides a specific technique to improve the devices transmit and receive data across the network corresponding to the user's request and appropriate match for the request. When compared with the existing art, the system filters the criteria thereby removing unnecessary data to be processed and focuses on the data relevant to the customer and selects the dealership. In other words, filtering the data for consideration minimizes the data intensive tasks to be performed by the system. Processing only the relevant data presents an technological improvement in an automobile purchase transaction.

For example, the system allows the automotive retail sales representative to filter and search for multiple vehicles based on type, year of manufacture, brand/manufacturer, model name, trim, drive train, manufacturer's suggested retail price (MSRP), payment options etc. Further, the system allows the automotive retail sales representative to track the automotive sales industry's business cycle, client cycle etc. Further, the system allows the automotive retail sales representative to switch the payment options between lease, finance and cash. Further, the system allows the automotive retail sales representative to send a message (e.g., email) to a fleet manager i.e., dealership for invoice. Furthermore, the system allows the automotive retail sales representative to send a credit application to the customer to submit for approval. The system allows the automotive retail sales representative to send a quote sheet to the customer with detailed financing options having up to five (5) different vehicles based on his selection. Further, the system allows the automotive retail sales representative to create a buyer's order with all custom variables. In addition, the system allows the automotive retail sales representative to create a worksheet to send to a dealer to show how the automotive retail sales representative has structured the deal for the customer. Furthermore, the system allows the automotive retail sales representative to send a lease return take-in form to obtain customer's lease return information. Subsequently, the system allows the automotive retail sales representative to send payoff authorization form to the customer to payoff the remaining balance. Here, a copy is also provided to the dealer so that they can make that payoff.

In another advantageous feature of the present subject matter, the system allows the automotive retail sales and/or lease representative to provide one-stop solution to get customer's information, select appropriate automobile, check dealer inventory, request invoice from the dealer, send credit applications and buyer's order to the customer. This enables the automotive retail sales representative to give customers instant pricing based on their inquiries and conveniently compare different filter options.

Features and advantages of the subject matter hereof will become more apparent in light of the following detailed description of selected embodiments, as illustrated in the accompanying FIGURES. As will be realised, the subject matter disclosed is capable of modifications in various respects, all without departing from the scope of the subject matter. Accordingly, the drawings and the description are to be regarded as illustrative in nature.

### BRIEF DESCRIPTION OF THE DRAWINGS

Further features and advantages of the present subject matter will become apparent from the following detailed description, taken in combination with the appended drawings, in which:

FIG. 1 illustrates an exemplary network communications system, in accordance with one embodiment of present subject matter;

FIG. 2 illustrates a diagrammatic representation of the system, in accordance with one embodiment of present subject matter;

FIG. 3 illustrates a block diagram of a host device and/or a server, in accordance with one embodiment of the subject matter;

FIG. 4 shows an exemplary automobile transaction structure, in accordance with one embodiment of the subject matter;

FIG. 5 illustrates a method of facilitating purchase of an automobile, in accordance with one embodiment of the subject matter; and

FIGS. 6 through 16 illustrate exemplary interfaces and buyer order, in accordance with one embodiment of the subject matter.

It will be noted that throughout the appended drawings, like features are identified by like reference numerals.

### DETAILED DESCRIPTION OF THE EMBODIMENTS

Before the present features and working principle of a system for facilitating purchase of an automobile is described, it is to be understood that this subject matter is not limited to the particular system as described, since it may vary within the specification indicated. Various features for facilitating purchase of an automobile might be provided by introducing variations within the components/subcomponents disclosed herein. It is also to be understood that the terminology used in the description is for the purpose of describing the particular versions or embodiments only, and is not intended to limit the scope of the present subject matter, which will be limited only by the appended claims. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It should be understood that the present subject matter describes a system and method of facilitating purchase of an automobile. The system receives information from an automotive sales representative as they assist a potential customer identify which vehicles meet their objectives. The system can provide a monthly payment quote for lease and finance transactions, as well as provide a total amount due for purchase transactions. The system allows the user to filter all vehicles in the user's database by payment, type of vehicle, manufacturer, drivetrain, model, trim, MSRP, year and provide instant quotes based upon a variety of customer variables including but not limited to: customer's credit-approval tier, total due at signing, positive or negative equity trade-in vehicles, applicable taxes, registration, dealer documentation fees, and customer-qualified rebates such as loyalty, conquest, recent graduate, military, etc. The system allows the automotive sales representative to quickly select up to 5 vehicles at one time and quickly send off a quote to the customer comparing all vehicles side by side. Once the customer decides on the vehicle, the system allows the automotive sales representative to finalize the deal structure, record necessary documentation, add other vehicles currently in the household to the customer's profile and add those vehicle's lease expiration or loan payoff dates to the automotive sales representatives list of future leads, utilize the system's one click feature to send credit application to the customer, create and send buyer's order to the customer, create deal worksheet to send to the dealer, and send Lease Return Take-In Form and Payoff Authorization Form to the customer if applicable. The system will record the sale and the delivery and schedule that client to be re-contacted 3 months before this newly delivered lease contract expires or in the case of finance transactions, the system will record and schedule the user to re-contact the client 3 months before they're scheduled to pay off their loan. Ultimately, this system was designed to best allow an automotive retail sales representative to automate the most time consuming tasks in their daily operation allowing them to spend more time learning about the client's needs and creating a better retail sales experience for their customer. In addition to the efficiency and time saving aspects of the system, it also increases accuracy and productivity through the automation of such tasks.

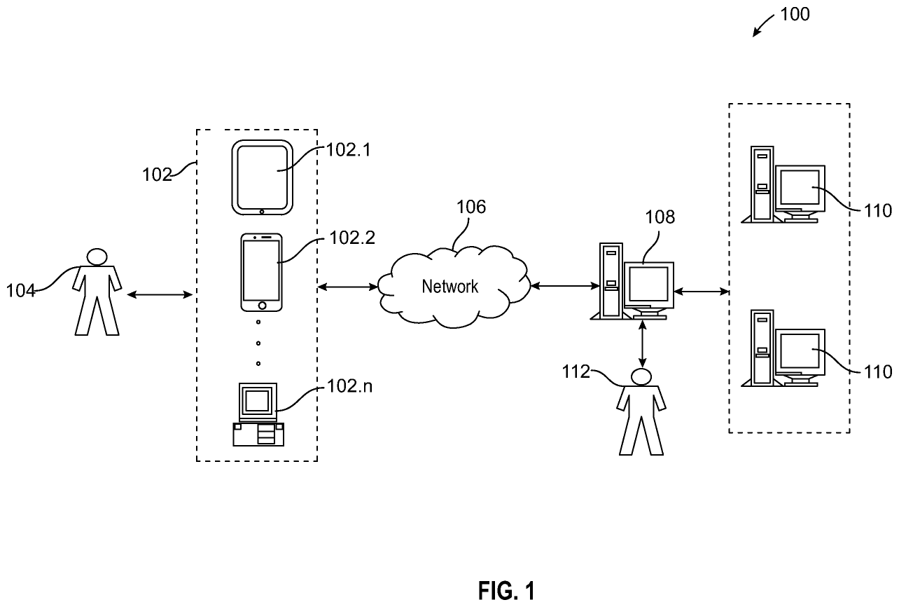

Various features and embodiments of the system for facilitating purchase of an automobile are explained in conjunction with the description of FIGS. 1-15.

The present subject matter discloses a system for facilitating purchase of an automobile. The system may be realised in a network communications system. FIG. 1 shows a high-level block diagram of an exemplary network communications system 100, such as a client-server environment associated with network communications system 100, in accordance with one embodiment of the present subject matter. For ease of reference, network communications system 100 is referred as system 100 throughout the description. System 100 includes one or more client devices such as client device 102.1, client device 102.2 client device 102.n, collectively referred as client devices or simply client device 102. Client device 102 indicates an electronic device such as a mobile device, a personal digital assistant, a laptop computer, a tablet computer, a desktop computer etc. In the present subject matter, a customer 104 operates client device 102. Customer 104 indicates an individual or business in search of purchasing a new automobile.

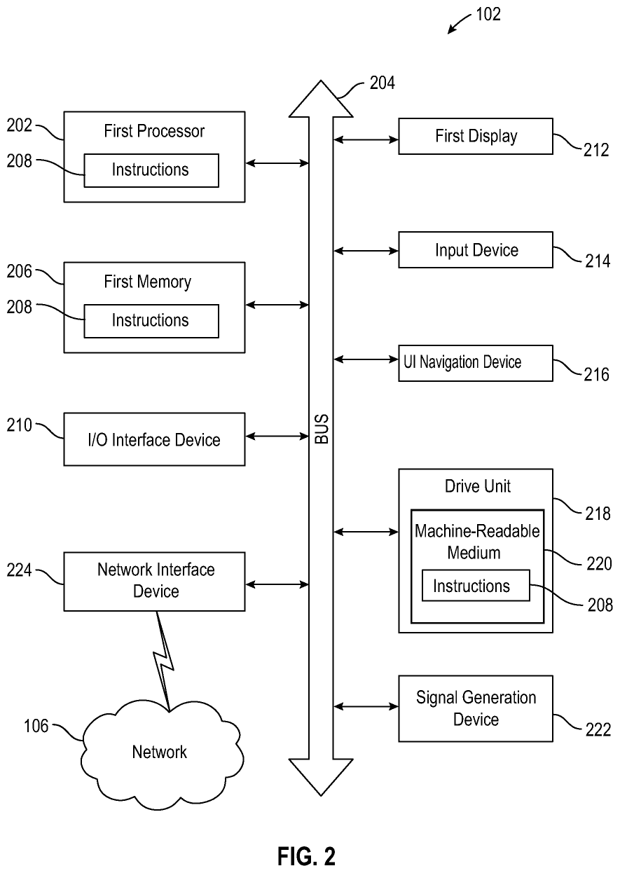

FIG. 2 shows a diagrammatic representation of client device 102, in accordance with one embodiment of present subject matter. Client device 102 encompasses a first processor 202 (e.g., a central processing unit (CPU), a graphics processing unit (GPU) or both). First processor 202 electrically couples by a data bus 204 to a first memory 206. First memory 206 includes a volatile memory and/or a non-volatile memory. Preferably, first memory 206 stores instructions or software program 208 that interact with the other devices in client device 102 and/or system 100 as described below. In one implementation, first processor 202 executes instructions 208 stored in first memory 206 in any suitable manner. In one implementation, first memory 206 stores digital data indicative of documents, files, programs, web pages, etc. retrieved from one of a host device 108, a server 110 and an input device 214.

Client device 102 further includes a first display 212 (e.g., a liquid crystal display (LCD) or a cathode ray tube (CRT)). Client device 102 includes an input device (e.g., a keyboard) and/or a touchscreen 214, a user interface (UI) navigation device 216 (e.g., a mouse), a drive unit 218, a signal generation device 222 (e.g., a speaker) and a network interface device 224.

Drive unit 218 includes a machine-readable medium 220 on which one or more sets of instructions and data structures (e.g., software 208) is stored. It should be understood that the term “machine-readable medium” includes a single medium or multiple medium (e.g., a centralised or distributed database, and/or associated caches and servers) that stores one or more sets of instructions. The term “machine-readable medium” also includes any medium that is capable of storing, encoding or carrying a set of instructions for execution by the machine and that cause the machine to perform any one or more of the methodologies of the present subject matter, or that is capable of storing, encoding or carrying data structures utilised by or associated with such a set of instructions. The term “machine-readable medium” accordingly includes, but not be limited to, solid-state memories, optical and magnetic media, and carrier wave signals.

Instructions 208 reside, completely or at least partially, within first memory 206 and/or within first processor 202 during execution thereof by client device 102. Network interface device 224 transmits or receives instructions 208 over network 106 utilising any one of a number of well-known transfer protocols.

Network 106 includes a wireless network, a wired network or a combination thereof. Network 106 can be implemented as one of the different types of networks, such as intranet, local area network (LAN), wide area network (WAN), the internet, and the like. Network 106 implements as a dedicated network or a shared network. The shared network represents an association of the different types of networks that use a variety of protocols, for example, Hypertext Transfer Protocol (HTTP), Transmission Control Protocol/Internet Protocol (TCP/IP), Wireless Application Protocol (WAP), and the like, to communicate with one another. Further the network 106 includes a variety of network devices, including routers, bridges, servers, computing devices, storage devices, and the like.

Client device 102 communicates with a host device 108 and/or one or more servers 110 (or simply referred as a server 110) via network 106. In one implementation, host device 108 indicates an electronic device such as a mobile device, a personal digital assistant, a laptop computer, a tablet computer, a desktop computer etc. Host device 108 and/or server 110 store one or more of a plurality of files, programs, databases, and/or web pages in one or more memories for use by client device(s) 102, and/or other host device(s) 108 or server(s) 110. In one implementation, server 110 interacts directly with client device 102 without the need for host device 108. In such an implementation, server 110 may be configured according to its particular operating system, applications, memory, hardware, etc., and may provide various options for managing the execution of the programs and applications, as well as various administrative tasks. Here, an automotive retail sales representative or broker 112 accesses server 110 directly and interacts with client device(s) 102. Automotive retail sales representative 112 indicates a middle man or broker or automotive broker or automobile broker or new car dealer/dealership or used car dealership receiving a request from customer 104 for purchasing an automobile and identifying suitable a dealer or manufacturer having inventory to sell the automobile to customer 104. As such, automotive retail sales representative 112 facilitates automobile transaction based on the request from customer 104.

In one alternate implementation, automotive retail sales representative 112 operates host device 108 which interacts with server 110 and client device(s) 102. Here, server 110 stores particular operating system, applications, memory, hardware, etc., and provides various options for managing the execution of the programs and applications, as well as various administrative tasks. Host device 108 acts a front interface device for server 110 and allows client device(s) 102 to access server 110. In such an implementation, host device 108 and server 110 are operated by a separate and distinct entities that interact together according to some agreed upon protocol. For example, automotive retail sales representative 112 may operate host device 108 and car manufacturer or dealer/dealership (not shown) may operate server 110. Here, host device 108 interacts with a large number of customers 104 at a plurality of different client devices 102 such as client device 102.1, client device 102.2 . . . client device 102.n. Accordingly, each host device 108 includes a high end computer with a large storage capacity, one or more fast microprocessors, and one or more high speed network connections. Conversely, each client device 102 includes less storage capacity, a single microprocessor, and a single network connection relative to a typical host device 108.

Based on the above, a person skilled in the art understands that host device 108 or server 110 may be configured according to its particular operating system, applications, memory, hardware, etc., and may provide various options for managing the execution of the programs and applications, as well as various administrative tasks independently or as same entities.

The present description is explained considering that server 110 stores applications, memory, hardware, etc., and provides various options for managing the execution of the programs and applications. Host device 108 receives information from client device 102 and performs various administrative tasks and enables to execute and operate applications, memory, hardware, etc. for managing the execution of the programs and applications at server 110.

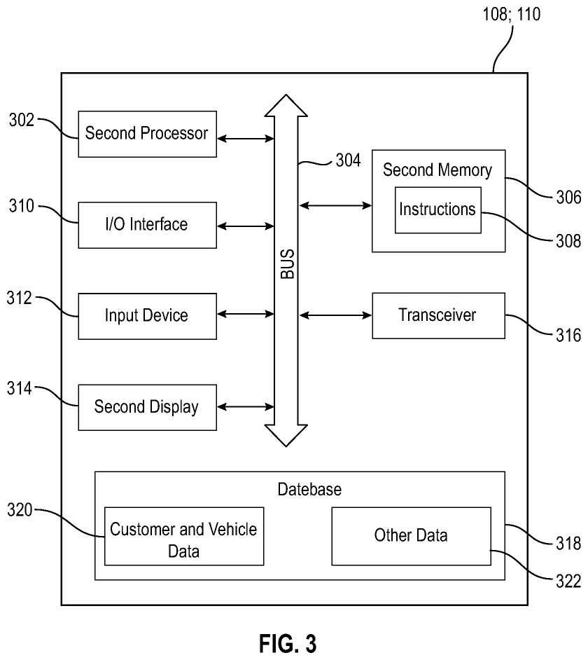

FIG. 3 illustrates a block diagram of host device 108 and/or server 110 illustrated in FIG. 1, in accordance with one embodiment of the present subject matter. Host device 108 and/or server 110 encompasses a second processor 302 (e.g., a central processing unit (CPU), a graphics processing unit (GPU) or both). Second processor 302 electrically couples by a data bus 304 to a second memory 306. Second memory 306 includes a volatile memory and non-volatile memory. Preferably, second memory 306 stores instructions or software program 308 that interact with the other devices in host device 108 and/or server 110. In one implementation, second processor 302 executes instructions 308 stored in second memory 306 in any suitable manner. In one implementation, second memory 306 stores digital data indicative of documents, files, programs, web pages, etc.

Host device 108 and/or server 110 further includes an input/output (I/O) interface 310, an input device (e.g., a keyboard) and/or a touchscreen 312, a second display 314 (e.g., a liquid crystal display (LCD) or a cathode ray tube (CRT)) and a transceiver 316. Transceiver 316 transmits or receives instructions 308 over network 106 utilising any one of a number of well-known transfer protocols.

Host device 108 and/or server 110 includes a database 318. Database 318 indicates data structure configured for storing information. In the current embodiment, database 318 includes customer and vehicle data 320, and other data 322. Customer and vehicle data 320 includes data corresponding to customers 104 and automobiles. For example, customer and vehicle data 320 includes name, address, vehicle data such as vehicle or automobile type, manufacturer, manufacturing date, model number, maintenance schedule, inventory data, location of the inventory, manufacturing data, configuration data, historical data, access and usage data, commission data, operations data, etc.

As specified above, automotive retail sales representative 112 operates host device 108 and/or server 110. Each of host device 108 and server 110 is controlled by an appropriate software having security measures. Each of host device 108 and server 110 configures to provide access to one or more automotive retail sales representatives 112 for performing certain actions and/or modify data. Accordingly, one or more automotive retail sales representatives 112 registers with host device 108 and server 110 to receive requests from customer(s) 104, access inventory data, communicate with dealer(s), submit requests, manipulate data, provide pricing information and offer/generate a quote to customer 104, etc.

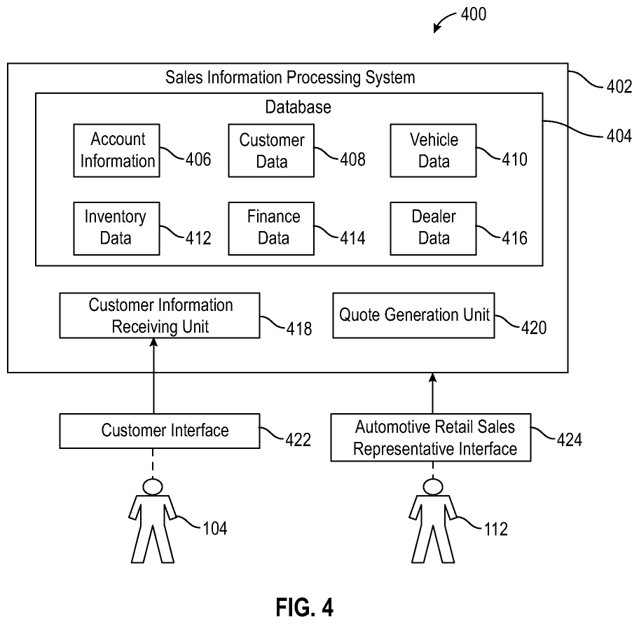

FIG. 4 shows an exemplary automobile transaction structure 400, in accordance with one embodiment of the present subject matter. Automobile transaction structure 400 includes a sales information processing system 402. In one example, sales information processing system 402 implements in host device 108 and accesses information stored in server 110. Alternatively, sales information processing system 402 implements in server 110. Sales information processing system 402 includes a database 404 storing account information 406, customer data 408, vehicle data 410, inventory data 412, finance data 414 and dealer data 416.

Account information 406 includes data corresponding to automotive retail sales representative(s) 112 such as names, unique identification numbers such as employee number, login credentials, actions that the automotive retail sales representative 112 can perform while accessing sales information processing system 402, etc. Customer data 408 includes all information pertaining to customer 104 such as name, address, pin code, location, details of automobile the customer 104 wishes to purchase, budget, finance preferences, etc. Vehicle data 410 includes data available for automobiles in the market such as vehicle or automobile type, manufacturer, year of manufacturer, mileage, features, trim, drivetrain, etc., and/or automobiles in inventory with a dealer. Inventory data 412 includes inventory i.e., number of automobiles available with the dealer. Finance data 414 includes data corresponding to finance institutions such as banks collaborating with automotive retail sales representative(s) 112 to facilitate automobile transaction. In one example, finance data includes a purchasing option that allows the customer to purchase the automobile by paying the financed amount with the duration of the term agreed upon. Dealer data 416 includes name, location, contact information of the dealers(s) selling the automobile.

Further, sales information processing system 402 includes a customer information receiving unit 418 that interacts with customer interface 422 to receive request from the customer 104. In one example, customer 104 interacts with automotive retail sales representative 112 via a telephone call, text messages or email communication to collect information from customer 104. Subsequently, automotive retail sales representative 112 enters details of customer 104 collected via calling, texting or email into sales information processing system 402. Further, sales information processing system 402 includes a quote generation unit 420 that generates a quote after selecting the automobile based on the request submitted by customer 104. The quote includes payment or sale price provided to customer 104 based on the customer's desired automobile and desired purchasing structure. In the present subject matter, customer 104 accesses sales information processing system 402 through customer interface 422 presented to him/her on client device 102. Further, automotive retail sales representative 112 accesses sales information processing system 402 through automotive retail sales representative interface 424 presented to him/her on host device 180. Although FIG. 4 shows that customer interface 422 and automotive retail sales representative interface 424 are separate from sales information processing system 402, person skilled in the art appreciates that customer interface 422 and automotive retail sales representative interface 424 may implement as part of sales information processing system 402 without deviating from the scope of the present subject matter.

In accordance with present subject matter, customer 104 interacts with sales information processing system 402 via customer interface 422. Here, customer 104 interacts with customer interface 422 to research or enquire automobiles he/she is interested to purchase. Customer 104 provides information such as name, address, phone number, automobile specification, price range, mileage needed, applicable tax, any specific requirement, etc. The information is considered as a lead information for sales information processing system 402 (i.e., automotive retail sales representative 112). Here, a lead indicates a customer i.e., individual or business in search of purchasing automobile. Customer information receiving unit 418 receives the information from customer 104 and stores as customer data 408 in database 404.

After receiving the request, automotive retail sales representative 112 accesses sales information processing system 402 via automotive retail sales representative interface 424 to facilitate automobile transaction for customer 104 based on the request. As specified above, automotive retail sales representative 112 may indicate a middle man or sales representative or an employee or a franchise or a non-franchise entity performing sales and quoting tasks for customer 104. Automotive retail sales representative 112 accesses database 404 and uses information from customer 104, dealers, market pricing, reports, finance data to provide sales quote or buyer order for customer 104.

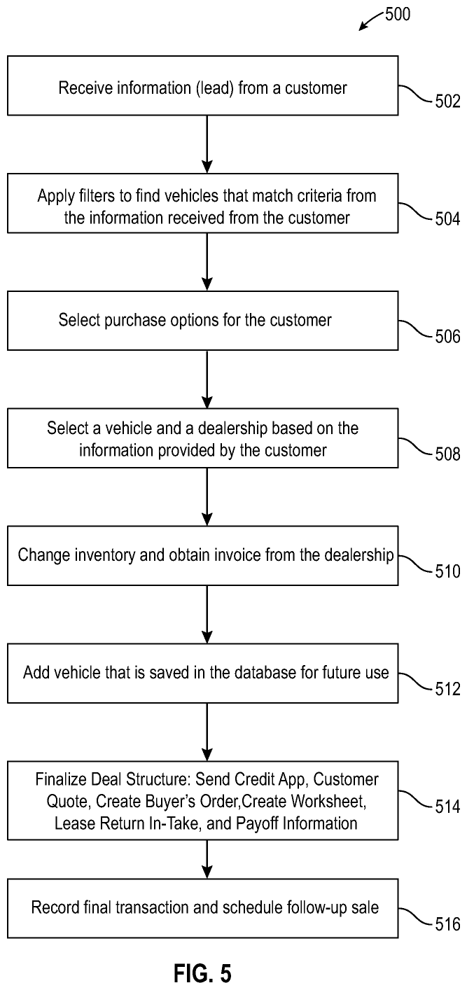

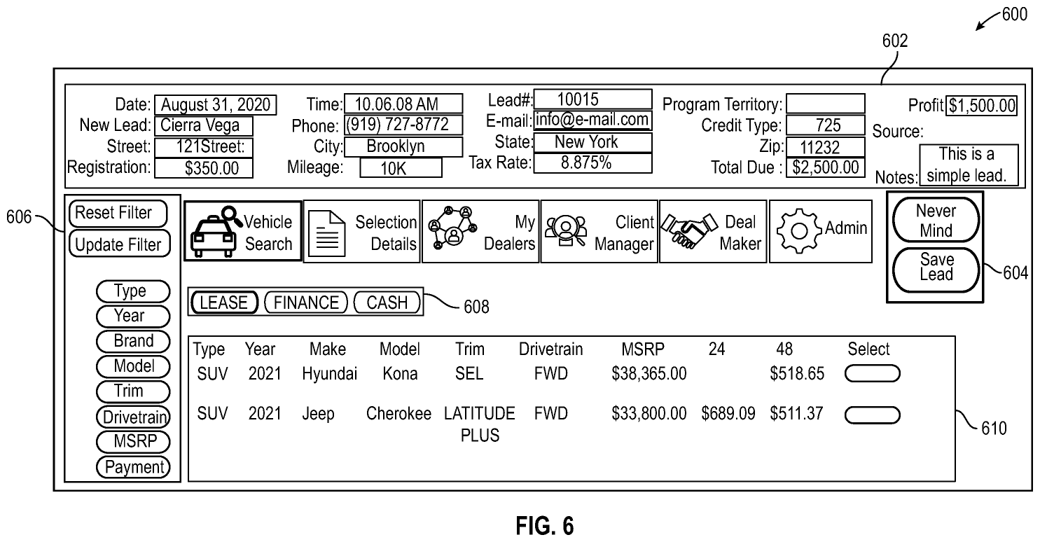

FIG. 5 illustrates a method 500 of facilitating purchase of an automobile based on requirement of customer 104 by automotive retail sales representative 112, in accordance with one exemplary embodiment of the present subject matter. The order in which method 500 is described should not be construed as a limitation, and any number of the described method blocks can be combined in any order to implement method 500 or alternate methods. Additionally, individual blocks may be deleted from method 500 without departing from the spirit and scope of the subject matter described herein. Furthermore, method 500 can be implemented in any suitable hardware, software, firmware, or combination thereof. However, for ease of explanation, in the embodiments described below, method 500 may be implemented using the above-described sales information processing system 402 (and/or host device 108 or server 110). Method 500 is explained in conjunction with FIG. 4 and exemplary interfaces illustrated in FIGS. 6 through 15.

At first, sales information processing system 402 receives information (lead) from customer 104 via customer information receiving unit 418. The information includes, but is not limited to, automobile he/she wishes to purchase, budget, finance preferences, etc., as shown at step 502. After receiving the information, automotive retail sales representative 112 accesses sales information processing system 402 via automotive retail sales representative interface 424. FIG. 6 illustrates an exemplary interface 600 presented to automotive retail sales representative 112 on second display 314. Interface 600 includes a first section 602, a second section 604, a third section 606, a fourth section 608 and a fifth section 610. First section 602 presents lead information of customer 104. Here, interface 600 acts as a dashboard for automotive retail sales representative 112. First section 602 remains at the top at all times. Automotive retail sales representative 112 changes or updates particulars/details of customer 104. For example, consider automotive retail sales representative 112 changes the location of customer, then sales information processing system 402 automatically retrieves relevant information from database 404 and updates other particulars in first section 602. Second section 604 includes a save option allowing automotive retail sales representative 112 to save the updated particulars of the customer 104 in database 404.

Third section 606 includes filters allowing automotive retail sales representative 112 to filter the criteria to find an appropriate automobile for the customer 104 based on his/her request. The filters may include, but are not limited to, vehicle or automobile type, year of manufacture, make, model, trim, drivetrain, Manufacturer Suggested Retail Price (MSRP), payment, etc. In one example, the automobile type include, but not limited to, SUV, Sedan, Pickup, Minivan, Coupe, etc. Make indicates manufacturer or brand such as Ford™, Toyota™, Hyundai™, BMW™, Lexus™, Tesla™, Mercedes™, etc. Drivetrain includes, but not limited to, front-wheel drive, all-wheel drive, rear-wheel drive, four-wheel drive(4WD), etc. Third section 606 illustrates exemplary filters applied to select one or more automobiles for the customer 104. Sales information processing system 402 allows automotive retail sales representative 112 to reset or update and apply filters to vehicles that match criteria from the information received from customer 104 (step 504).

After filtering, sales information processing system 402 allows automotive retail sales representative 112 to compare a plurality of automobiles available and select one or more automobiles appropriate for the customer 104, in accordance with one exemplary embodiment of the present invention. Here, sales information processing system 402 helps to compare the vehicles based on the type, drivetrain and model (e.g., model name or model number) of the automobiles. The type of vehicles includes, but not limited to, SUV, sedan, hatchback, coupe, etc. Drivetrain includes, but not limited to, Front Wheel Drive (FWD), Rear Wheel Drive (RWD), Four Wheel Drive (4WD) and All Wheel Drive (AWD). Model includes, but not limited to, manufacturer and variant of the vehicle. In the present example, when automotive retail sales representative 112 selects the type of the vehicle and the drivetrain, the sales information processing system 402 displays only few brands having the type of the vehicle and drivetrain. This filters reduces the total of automobiles needed to be matched with the one or more automobiles received in the request from the customer.

In addition, the sales information processing system 402 allows automotive retail sales representative 112 to compare the automobiles by imposing a relationship based on the MSRP of the automobiles selected and displays only the automobiles that are in the same category in terms of the price points. The relationship comparison can be configured to 10%, 20% or 100& match on the selected automobiles.

Fourth section 608 presents purchase options (step 506) such as lease, finance and cash to provide a purchase structure for customer 104. Based on the filer selected in third section 606 and purchase option 608 selected in fifth section 608, sales information processing system 402 generates instant quotes and presents in fifth section 610. Here, sales information processing system 402 provides instant quotes for vehicles by type, year, make, model, trim, drivetrain, Manufacturer's Suggested Retail Price (MSRP), and Monthly Payment such as 36, 39, 42 months and so on. Subsequently, automotive retail sales representative 112 selects an automobile from the list presented that is appropriate for customer 104 (step 508). Upon selection of the automobile , automotive retail sales representative 112 selects a dealership which best pricing for the automobile selected for customer 104.

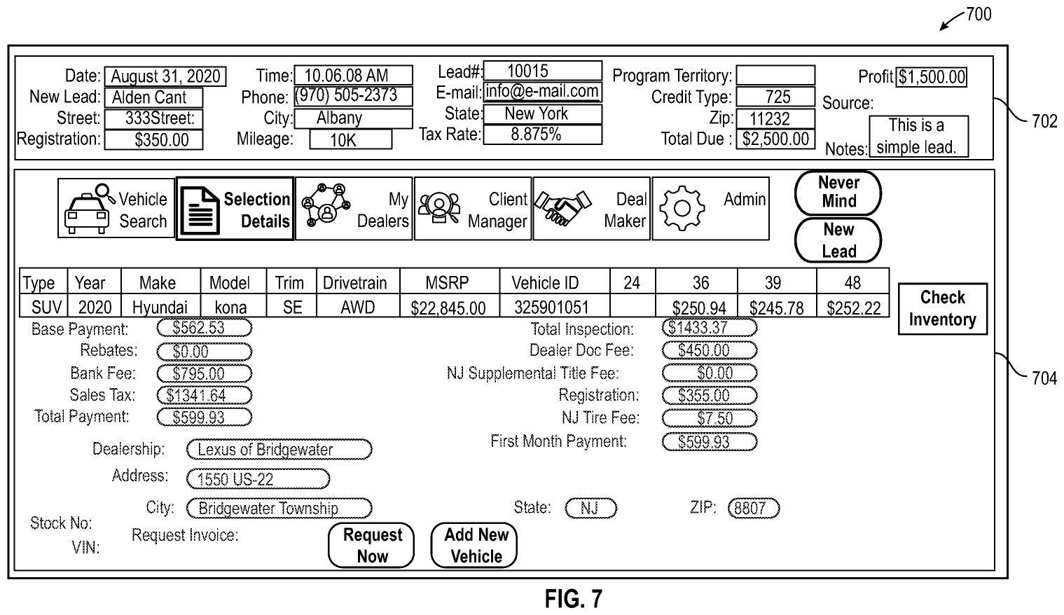

FIG. 7 shows an exemplary interface 700 selecting a dealership for automobile selected for customer 104. Interface 700 includes a first section 702 and a second section 704. First section 702 presents lead information of customer 104 as presented above. Second section 704 presents dealership information and pricing for the automobile selected. Here, automotive retail sales representative 112 checks or changes inventory of automobile in real-time and obtains an invoice from the dealership (step 510). In order to check the inventory, automotive retail sales representative 112 selects “check inventory tab”. Selecting the check inventory tab takes to a website of the dealer selected. Alternatively, sales information processing system 402 retrieves details of inventory of dealer and presents to automotive retail sales representative 112. Further, automotive retail sales representative 112 requests an invoice from dealership (fleet manager) for the automobile selected for customer 104. If needed, automotive retail sales representative 112 provides details for additional automobile. The dealer provides invoice to automotive retail sales representative 112 for the automobile selected. Subsequently, sales information processing system 402 calculates amount to be paid and presents a deal structure (i.e., deal maker tab). Here, sales information processing system 402 moves the lead information, automobile information, and deal structure to a “deal maker tab”.

At step 512, automotive retail sales representative 112 adds the vehicle that is saved in database 404 for future use. At step 514, automotive retail sales representative 112 finalizes the deal structure, sends credit app, customer quote, creates buyer's order, creates worksheet, leases return in-take, and payoff information”. Subsequently, automotive retail sales representative 112 records final transaction and schedule follow-up sale (step 516).

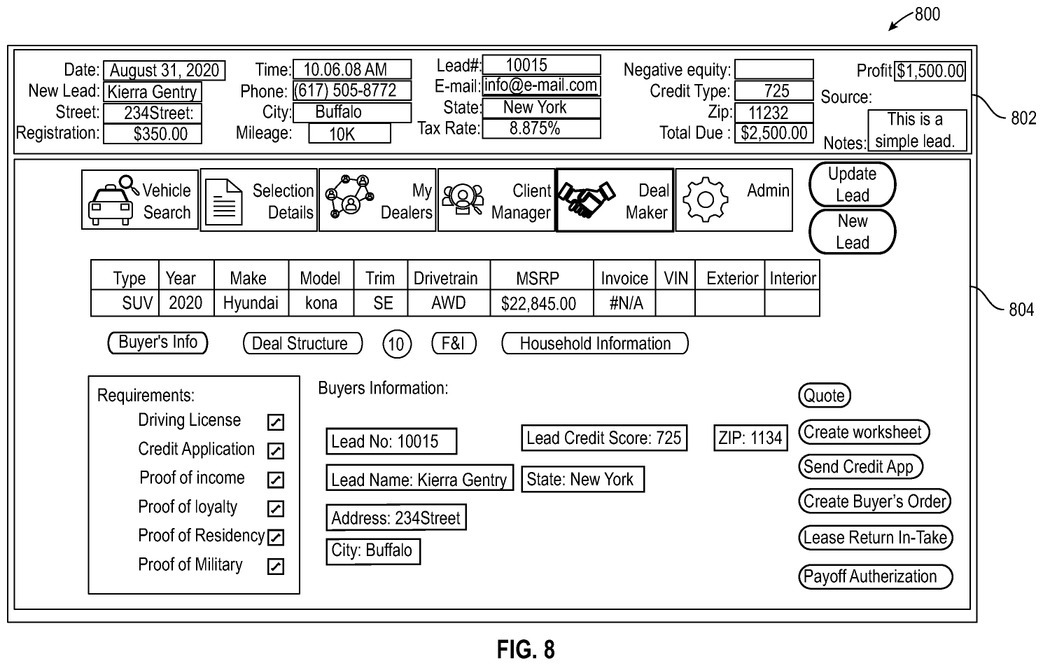

FIGS. 8 to 11 shows exemplary interfaces of a deal maker tab. Through the deal maker tab, sales information processing system 402 allows automotive retail sales representative 112 to send a credit application, customer quote, create buyer's order, create worksheet, lease return in-take, and payoff information to customer 104 or dealership automatically by e-mail and/or print. Deal maker tab allows to organise and finalise final structure, access deal details such as APR, Money Factor, Rebates, and Residual Values, input and save proof of insurance information.

FIG. 8 shows an exemplary interface 800 for presenting buyer's information. Interface 800 includes a first section 802 and a second section 804. First section 802 presents lead information of customer 104 as presented above. Second section 804 presents a list of requirements that automotive retail sales representative 112 can use to save information for later reference as customer 104 provides. The buyer's information section also includes an opportunity to apply co-signer information if applicable to the deal. Automotive retail sales representative 112 finalises the deal for customer 104 including selecting the customer's final preferences for term and mileage (in the case of lease transactions). Sales information processing system 402 saves lease expiration information in a “client manager tab” to alert automotive retail sales representative 112 when the customer 104 will be back in the market for a new lease.

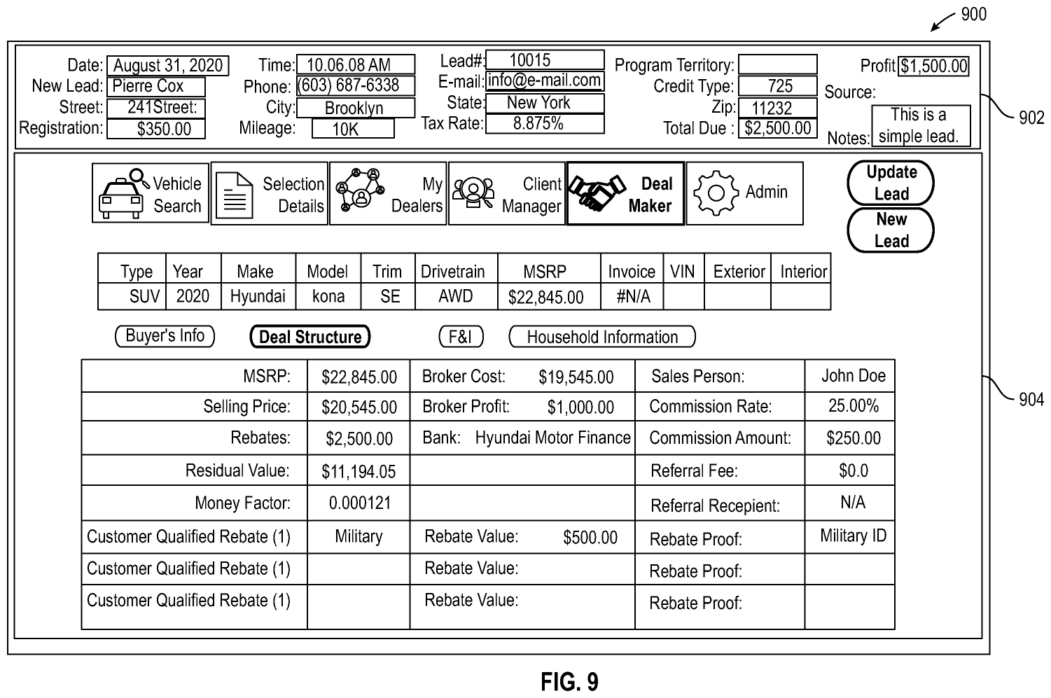

FIG. 9 shows an exemplary interface 900 for presenting a deal structure. Interface 900 includes a first section 902 and a second section 904. First section 902 presents lead information of customer 104 as presented above. Second section 904 presents automobile information. Here, sales information processing system 402 populates automobile information and selling price, automotive retail sales representative cost, profit, rebates, residual value, money factor/APR, bank, automotive retail sales representative profit, and calculates automotive retail sales representative's commission automatically. Here, commission indicates the amount of money automotive retail sales representative 112 charges above the cost the dealer allowed them to sell the automobile. The commission may also be termed as profit.

Further, sales information processing system 402 allows automotive retail sales representative 112 to add further rebates if the customer 104 qualifies, input the value of such rebate and automatically recalculates the payment.

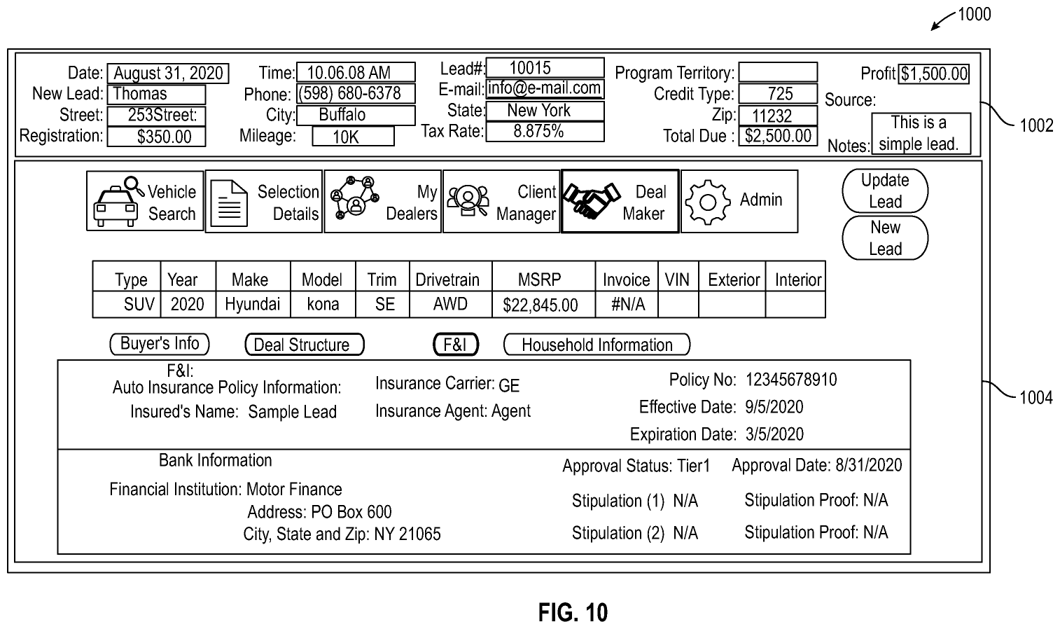

FIG. 10 shows an exemplary interface 1000 for presenting finance and insurance information for the automobile transaction. Interface 1000 includes a first section 1002 and a second section 1004. First section 1002 presents lead information of customer 104 as presented above. Second section 1004 presents insurance information. Here, sales information processing system 402 allows automotive retail sales representative 112 to save key insurance information in facilitating the proof of insurance requirement to complete the sale or purchase. In the bank information section, sales information processing system 402 allows automotive retail sales representative 112 to list the name of the financial institution providing the automotive lease or finance agreement. Further, sales information processing system 402 allows automotive retail sales representative 112 to add lien holder/additional insured address information to provide to the insurance carrier to be listed on the policy and insurance binder. Depending on the approval tier, the bank may issue an approval with stipulations such as proof of residence, proof of income, etc.

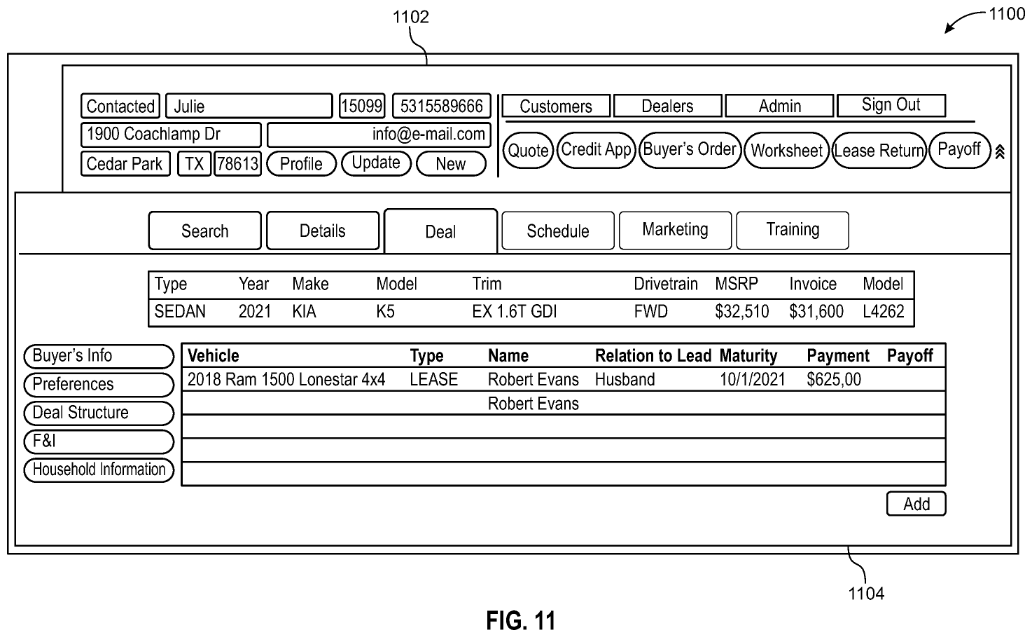

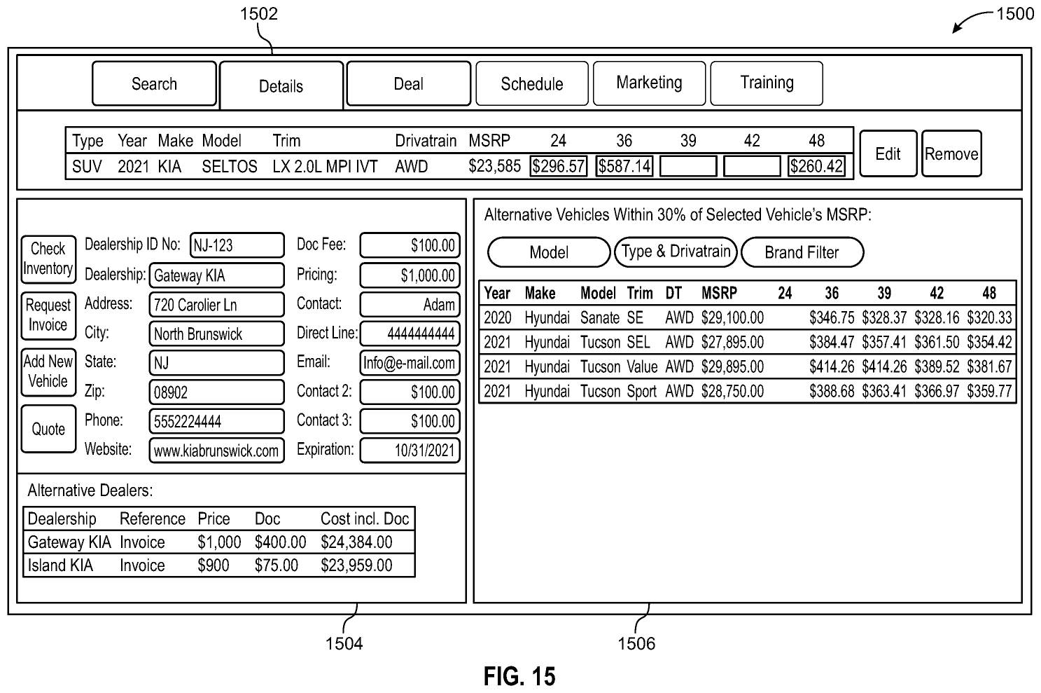

FIG. 11 shows an exemplary interface 1100 for presenting household information. Interface 1100 includes a first section 1102 and a second section 1104. First section 1102 presents lead information of customer 104 as presented above. Second section 1104 presents information corresponding to customer 104. The information includes lease or purchase information to know whether they have any other leases or finances in the household because that may qualify the potential customer for additional rebates such as loyalty, conquest, or competitive rebates. The information further includes the customer's preferred criteria for the one or more automobiles i.e., the specification of the automobiles, budget, location, a finance preference, etc. Automotive retail sales representative 112 saves the information and sales information processing system 402 creates a new lead record in the client manager tab (FIG. 15). This allows sales information processing system 402 to add lease expiration or finance expiration date in the automotive retail sales representative's reminders of potential leads and returning customers that are due to get out of their leases soon.

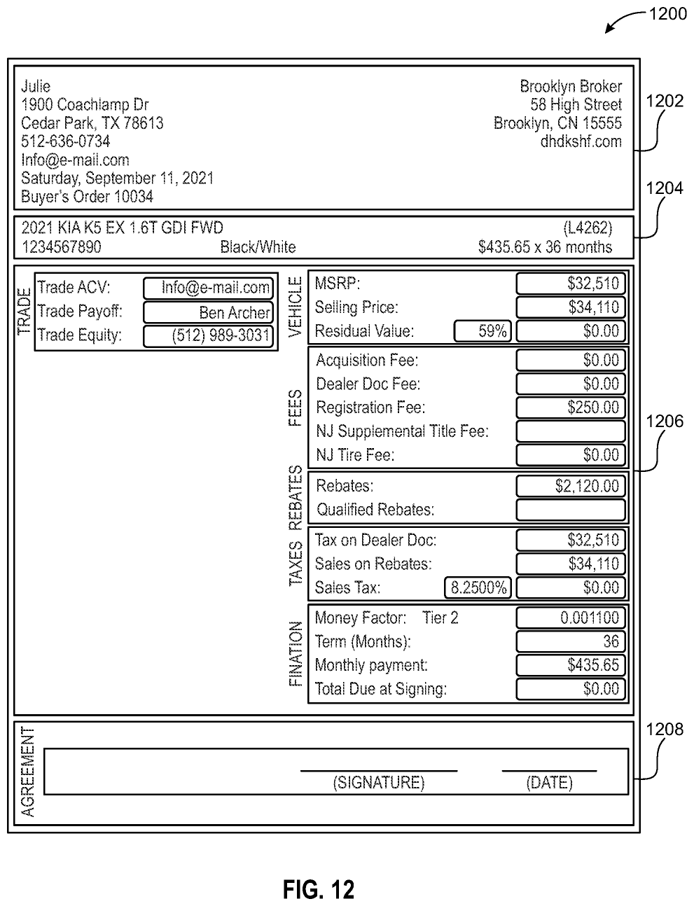

Subsequently, sales information processing system 402 generates a unique buyer's order number and automatically generates copy of buyer's order in different formats such as pdf, e-mail, and print function. FIG. 12 shows an exemplary interface 1200 of the buyer order. Buyer order includes buyer information 1202, vehicle information 1204, finance preference and lease structure 1206 and agreement 1208. The buyer order is transmitted to client device 102 via network 106.

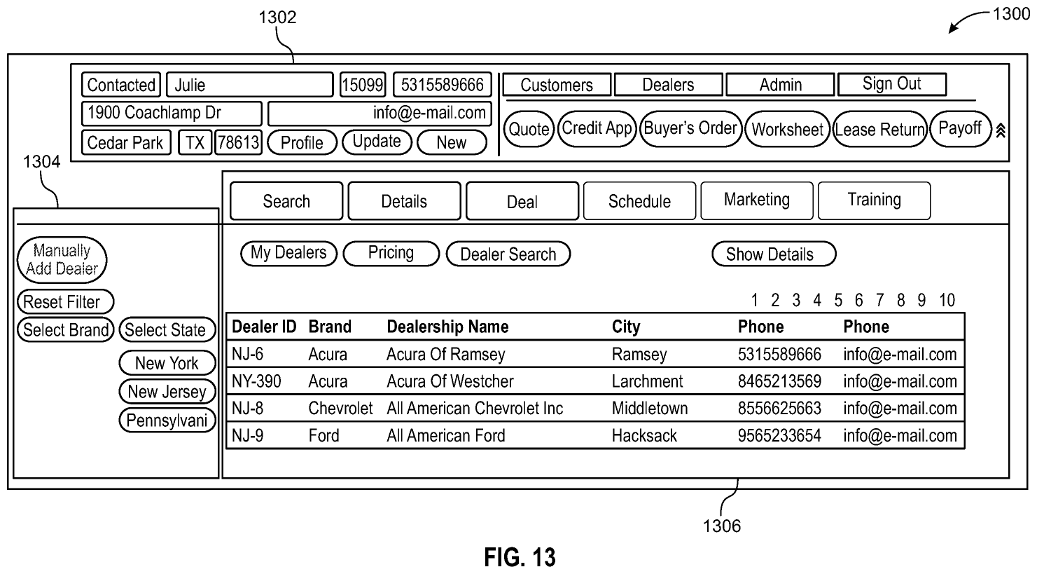

In one exemplary embodiment, sales information processing system 402 allows automotive retail sales representative 112 to find new dealers for any manufacture in the states that they work with. Automotive retail sales representative 112 adds contact information, pricing, and additional franchises sold at that location while also saving the information as a dealer record. FIG. 13 shows an exemplary interface 1300 for presenting dealer information. Interface 1300 includes a first section 1302, a second section 1304 and a third section 1306. First section 1302 presents lead information of customer 104 as presented above. Second section 1304 presents dealer information such as name, address (state) and so on. Third section 1306 provides details of the dealer such as their contact information for each of the vehicle. Automotive retail sales representative 112 can apply filters to shortlist the dealers to contact or delete/update dealer information depending on the need.

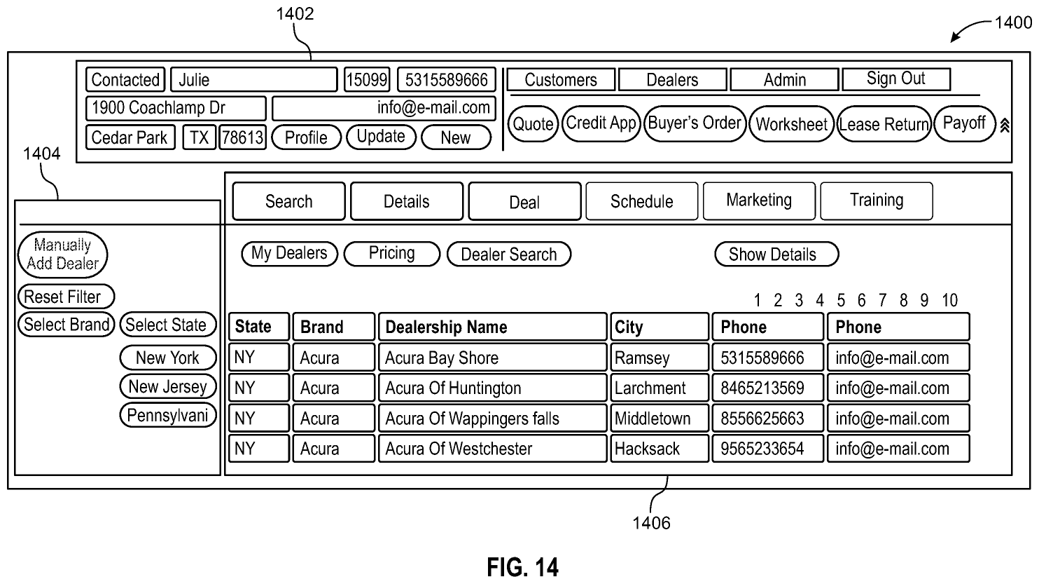

If a relationship falls apart or phases out with the dealer(s), then automotive retail sales representative 112 may delete dealer from dealers list. Optionally, automotive retail sales representative 112 may re-add the dealership back if things change in the future. FIG. 14 shows an exemplary interface 1400 for adding or deleting dealers. Interface 1400 includes a first section 1402, a second section 1404 and a third section 1406. First section 1402 presents lead information of customer 104 as presented above. Second section 1404 presents dealer information such as name, state, brands and so on that automotive retail sales representative 112 can use for seeking the dealer. Third section 1406 provides dealer details that automotive retail sales representative 112 can use to contact them to get details about the inventory and quote.

FIG. 15 shows an exemplary interface 1500 for checking inventory and obtaining invoice from a dealer. Interface 1500 includes a first section 1502, a second section 1504 and a third section 1506. First section 1502 presents vehicle information such as vehicle name, year of manufacturing, type of vehicle, type of drivetrain, etc. Second section 1504 presents dealer information including the options such as inventory, request invoice, etc. Third section 1506 presents offered by the dealer. Sales information processing system 402 allows the automotive retail sales representative 112 to check the inventory available at the dealer and requests the dealer to provide a quote for the automobile. The quote includes rates for the vehicle with a purchase structure of 24 months, 36 months and so on.

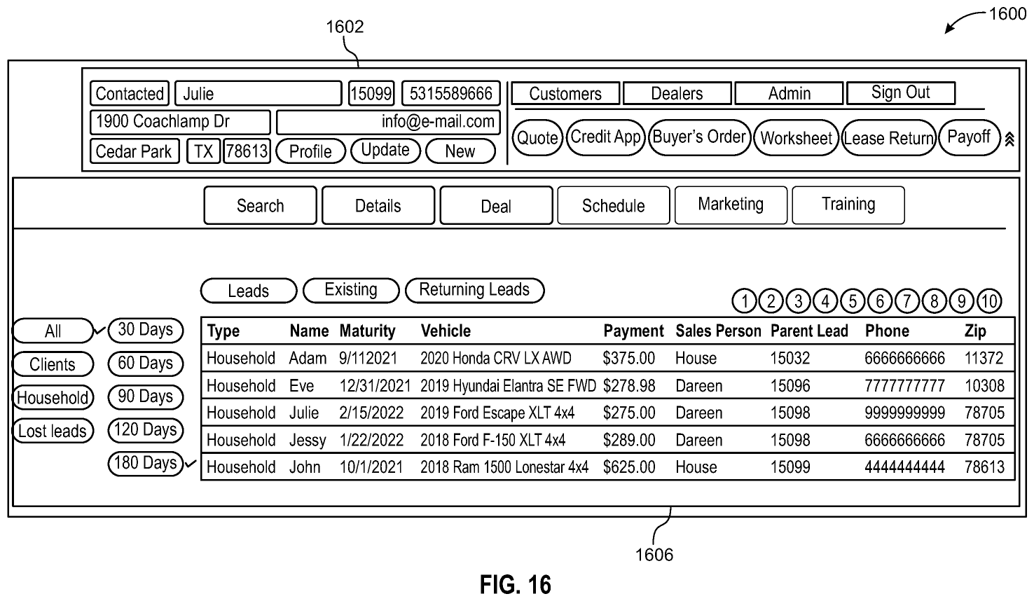

In one exemplary embodiment, sales information processing system 402 allows automotive retail sales representative 112 to manage client/customer data via client manager tab. FIG. 16 shows an exemplary interface 1600 for managing clients. Interface 1600 includes a first section 1602 and a second section 1606. First section 1602 presents lead information of customer 104 as presented above. Second section 1606 presents information that automotive retail sales representative 112 may input to get an alert when the customer will come back in the market for a new lease to pitch for new sale. Sales information processing system 402 allows the automotive retail sales representative 112 to customize details based on the automotive sales industry's business cycle, client cycle. For example, the sales information processing system 402 allows to manage lease return list of previous clients. This helps to record information to increase future sales for the automotive retail sales representative 112. In addition, the sales information processing system 402 allows to manage lease return list of previous customers' household vehicles. This helps to record information to increase future sales and buying for the automotive retail sales representative 112.

Additionally, sales information processing system 402 allows automotive retail sales representative 112 to edit defaults such as default shown profit on the user interface, the sales person's commission rate, the default automotive retail sales representative costs, automotive retail sales representative company's logo and contact information, along with adding additional users/automotive retail sales representatives to access sales information processing system 402.

Based on the above, it is evident that the presently disclosed system allows automotive retail sales representatives to perform sales and quoting tasks with ease. The system allows the automotive retail sales representative to select one or more appropriate vehicle/automobiles, payment option, dealership closest to customer and/or dealership which is offering best price applicable for the customer. Further, the system allows the automotive retail sales representative to filter the deal structure by registration, mileage per year (in the case of a lease structure), and update the payments by the amount of profit and the amount the potential customer would like to pay total due at signing.

The system helps customer to obtain a sales quote without having to physically visit the dealership or search extensively online for selecting an appropriate automobile for him/her. The presently disclosed system provides a sales quote and generates an agreement that the customer can sign before finalizing the deal.

Applicant or inventors of the present subject matter intend to market the system as “BrokerBuddy1” or “BB” or “Buddy Broker” or any other suitable names.

The present subject matter has been described in particular detail with respect to various possible embodiments, and those of skill in the art will appreciate that the subject matter may be practiced in other embodiments. First, the particular naming of the components, capitalization of terms, the attributes, data structures, or any other programming or structural aspect is not mandatory or significant, and the mechanisms that implement the subject matter or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present the features of the present subject matter in terms of algorithms and symbolic representations of operations on information. These algorithmic descriptions and representations are the means used by those skilled in the data processing arts to most effectively convey the substance of their work to others skilled in the art. These operations, while described functionally or logically, should be understood as being implemented by computer programs.

Further, certain aspects of the present subject matter include process steps and instructions described herein in the form of an algorithm. It should be noted that the process steps and instructions of the present subject matter could be embodied in software, firmware or hardware, and when embodied in software, could be downloaded to reside on and be operated from different platforms used by real time network operating systems.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present subject matter is not described with reference to any particular programming language. It is appreciated that a variety of programming languages may be used to implement the teachings of the present subject matter as described herein, and any references to specific languages are provided for disclosure of enablement and best mode of the present subject matter.

It should be understood that components shown in FIGUREs are provided for illustrative purpose only and should not be construed in limited sense. A person skilled in the art will appreciate alternate components that may be used to implement the embodiments of the present subject matter and such implementations will be within the scope of the present subject matter.

While preferred embodiments have been described above and illustrated in the accompanying drawings, it will be evident to those skilled in the art that modifications may be made without departing from this subject matter. Such modifications are considered as possible variants included in the scope of the subject matter.

What is claimed is:

1. A method of processing an automobile purchase transaction in a data communication network, the method comprising steps of:
receiving a request from a user device for one or more automobiles from a customer, the request comprising criteria for the one or more automobiles, the criteria comprising specification of the one or more automobiles, budget, location, and a finance preference;
accessing the request at a server over the internet, the server comprising a processor and a memory that stores the criteria, wherein the processor:
filters the criteria for identifying one or more appropriate automobiles amongst a plurality of automobiles by matching the criteria in the request;
provides a purchase structure based on the finance preference received in the request;
selects at least one dealer offering the one or more appropriate automobiles within the budget by matching the location of the customer and the at least one dealer, and the purchase structure over the data communication network;
checks an inventory of the one or more appropriate automobiles with the at least one dealer selected over the data communication network;
obtains a quote from the at least one dealer over the data communication network upon checking the inventory; and
generates a deal structure for the one or more appropriate automobiles based on the quote obtained from the dealer and the purchase structure.

2. The method of claim 1, further comprising transmitting, by the processor, the deal structure to the customer via the user device.

3. The method of claim 1, wherein the step of filtering the criteria for identifying one or more appropriate automobiles comprises:
searching the plurality of automobiles based on type, year of manufacture, manufacturer, model name, trim, drive train, manufacturer's suggested retail price (MSRP), and the finance preference.

4. The method of claim 3, further comprising comparing, by the processor, the plurality of automobiles based on the type, drive train, manufacturer, and model name.

5. The method of claim 1, wherein the step of generating the deal structure comprises generating a quote sheet and a buyer order for each of the one or more appropriate automobiles identified.

6. The method of claim 1, further comprising transmitting, by the processor, a credit application to the customer for submitting for an approval over the data communication network.

7. The method of claim 1, further comprising modifying, by the processor, the purchase structure by switching the finance preference.

8. The method of claim 1, further comprising checking, by the processor, rebates, insurance and other finance and insurance data applicable for the customer.

9. The method of claim 1, further comprising recording, by the processor, the request received from the customer and the deal structure generated corresponding to the request.

10. The method of claim 8, further comprising scheduling, by the processor, a follow up interaction based on the finance preference.

11. A system for processing an automobile purchase transaction in a data communication network, the system comprising:
a processor; and
a memory coupled to the processor, wherein the memory stores program instructions executed by the processor, to:
receive a request from a user device for one or more automobiles from a customer, wherein the request comprises criteria for the one or more automobiles, wherein the criteria comprises specification of the one or more automobiles, budget, location, and a finance preference;
access the request received from the customer;
filter the criteria to identify an one or more appropriate automobiles amongst a plurality of automobiles, wherein the criteria is filtered to match the one or more appropriate automobiles with the request;
provide a purchase structure based on the finance preference received in the request;
select at least one dealer offering the one or more appropriate automobiles within the budget, wherein the at least one dealer is selected by matching the location of the customer and the at least one dealer, and the purchase structure over the data communication network;
check an inventory of the one or more appropriate automobiles with the at least one dealer selected over the data communication network;
obtain a quote from the at least one dealer; and
generate a deal structure for the one or more appropriate automobiles based on the quote obtained from the dealer and the purchase structure.

12. The system of claim 11, wherein the processor executes the program instructions to transmit the deal structure to the customer over the data communication network to the user device.

13. The system of claim 11, wherein the processor executes the program instructions to filter the criteria by searching the plurality of automobiles based on type, year of manufacture, manufacturer, model name, trim, drive train, manufacturer's suggested retail price (MSRP), and the finance preference.

14. The system of claim 13, wherein the processor executes the program instructions to compare the plurality of automobiles based on the type, drive train, manufacturer, and model name.

15. The system of claim 11, wherein the processor executes the program instructions to generate a quote sheet and a buyer order for each of the one or more appropriate automobiles identified.

16. The system of claim 11, wherein the processor executes the program instructions to transmit a credit application to the customer to submit for approval over the data communication network.

17. The system of claim 11, wherein the processor executes the program instructions to modify the purchase structure by switching the finance preference.

18. The system of claim 11, wherein the processor executes the program instructions to check rebates, insurance and other finance and insurance data applicable for the customer.

19. The system of claim 11, wherein the processor executes the program instructions to record the request received from the customer and the deal structure generated corresponding to the request to schedule a follow up interaction based on the finance preference.

20. A non-transitory, computer-readable medium storing instructions that, when executed by a computer system for processing an automobile purchase transaction in a data communication network, configure the computer system for:
receiving, by a customer interface, a request for one or more automobiles from a customer, the request comprising criteria for the one or more automobiles, the criteria comprising specification of the one or more automobiles, budget, location, and a finance preference;
accessing the request received from the customer; filtering the criteria for identifying one or more appropriate automobiles amongst a plurality of automobiles, the one or more appropriate automobiles matching the criteria in the request;
providing a purchase structure based on the finance preference received in the request;
selecting at least one dealer offering the one or more appropriate automobiles within the budget by matching the location of the customer and the at least one dealer, and the purchase structure over the data communication network;
checking an inventory of the one or more appropriate automobiles with the at least one dealer selected over the data communication network;
obtaining the quote from the at least one dealer; and
generating a deal structure for the one or more appropriate automobiles based on the quote obtained from the dealer and the purchase structure.
